(19) United States
(12) Patent Application Publication
(10) Pub. No.: US 2010/0271694 A1
(43) Pub. Date: Oct. 28, 2010

(54) SOLAR MIRROR

(75) Inventor: David Bamber, Ormskirk (GB)

Correspondence Address: MARSHALL & MELHORN, LLC, FOUR SEAGATE - EIGHTH FLOOR, TOLEDO, OH, 43604, US

(73) Assignee: Pilkington Group Limited, St. Helens (GB)

(21) Appl. No.: 12/734,702

(22) PCT Filed: Nov. 18, 2008
(86) PCT No.: PCT/GB2008/051082

§ 371 Date: May 18, 2010

(30) Foreign Application Priority Data
Nov. 22, 2007 (GB) 0722906.5

(51) Int. Cl. G02B 5/08

(52) U.S. Cl. 359/360; 359/883

(57) ABSTRACT

A solar mirror comprising a transparent substrate (51) (e.g. clear float glass or low-iron glass), a reflective layer (53) (e.g. of silver) provided on a surface of the substrate, and a coating layer (54, 55) (e.g. a paint layer or other protective layer) provided over the reflective layer, wherein the reflective layer is provided in a thickness of at least 1600 Å.

The present invention relates to a solar mirror, especially to a mirror comprising a transparent substrate, a reflective layer and a coating layer.

Mirrors, typically comprising a clear glass substrate having a layer of a reflective metal such as silver on one of its surfaces, have been produced and used in the art for many years. A mirror may be flat (a plane mirror) or it may be curved, the latter typically being used to produce magnified or reduced images, or to focus light. Usage of mirrors is quite varied and wide-ranging from decoration and architecture to use in/with scientific instruments and devices.

A mirror can be quite a delicate object. To protect a mirror from factors such as atmospheric pollution, increased moisture levels, scratching and abrasion, which may reduce the reflectivity of a mirror, other layers may need to be incorporated into the mirror to protect it from these effects. It is known to protect a mirror with a layer containing another metal, such as copper or tin, to retard tarnishing of the silver layer, and also to protect this layer with one or more layers of a paint to increase its physical and chemical durability.

Maintaining the reflective integrity of a mirror is especially important when the mirror is intended for use in/with a scientific instrument or device, for example when the mirror is used to reflect and focus electromagnetic radiation (e.g. infrared (IR), visible and/or ultraviolet (UV) radiation) onto a device that is capable of collecting/generating energy, such as heat or electricity. Such a mirror is often referred to as a “solar mirror”. The degree of reflectance of the mirror is often critical to the operational efficiency of such a device, and typically high reflectivity (greater than 90%) must be maintained over the lifetime of the mirror, which may be of the order of twenty to thirty years.

In addition to the further layers described above that may be incorporated into a mirror to protect the reflective layer and prevent reduction of its reflection, a number of solutions have been proposed in the art to enhance the reflectivity of a mirror. One solution is to use a thin, low-iron glass as the substrate on which the reflective (silver) coating is deposited, to maximise the intensity of IR/visible/UV radiation incident on the reflective coating (having been transmitted by the glass) and subsequently reflected. An alternative solution is to provide a “stay-clean” or “self-clean” coating on the outer surface of the mirror (on the opposite surface of the substrate to the reflective coating)—not only does such a coating increase the cleanliness of the outer surface to maximise the intensity of light incident on the reflective coating, but it may also provide a degree of reflection itself (so called “front surface reflection”).

The problem of maintaining high reflectivity is typically more pronounced when a solar mirror is intended for use in a non-ambient environment, i.e. an environment having a non-ambient temperature or humidity level, especially those countries located in the “sun-belt” (i.e. a region extending from thirty degrees of latitude North of the equator to thirty degrees of latitude South of the equator). Despite the solutions provided by the prior art, loss of reflection in solar mirrors remains a problem. Furthermore in such environments, physical and chemical durability of such mirrors is also a problem, with light flecks and/or “fog” patches appearing in the reflective layer, which are areas of reduced reflectivity.

It would therefore be desirable to produce a mirror, especially a solar mirror, which does not suffer (at all or to the same extent) the problems that prior art mirrors experience, especially reduction in reflectivity over the lifetime of the mirror and poor physical and chemical durability, especially in harsher environments.

Accordingly the present invention provides a solar mirror comprising:

a transparent glass substrate,
a reflective layer provided on a surface of the substrate, and
a coating layer provided over the reflective layer, to protect the reflective layer,
wherein the reflective layer is provided in a thickness of at least 1600 Å.

Surprisingly, it appears that increasing the thickness of the reflective layer has the dual-effect of increasing the reflectivity of the solar mirror (the reflectivity remaining substantially constant over the lifetime of the mirror), despite reflectivity being a surface property, and improving the durability of the mirror, compared to prior art mirrors.

For the avoidance of doubt, the thickness of the reflective layer may also be quoted in the art as a weight per unit area, typically milligrams per square metre (mg/m²), however conversion between the two requires knowledge of the density of the material in question.

It is thought that the increased thickness in the reflective layer reduces or even eliminates the amount of UV radiation that is transmitted through the transparent glass substrate and then by the reflective layer to the coating layer below. In turn, this is thought to be beneficial because it is currently believed that UV radiation causes a chemical change and/or reaction in the coating layer, the product of which causes a chemical change and/or reaction in the reflective layer itself, leading to reduction in reflectivity in the affected areas.

The transparent glass substrate may be a pane of clear soda-lime-silica glass, preferably float glass. The composition of a typical pane of clear glass contains 70-73% SiO₂, 12-14% Na₂O, 7.5-10% CaO, 3-5% MgO, 0-2% Al₂O₃, 0-1% K₂O, 0-0.3% SO₃ and 0.07-0.13% Fe₂O₃ (total iron) which will ordinarily be present in both its oxidised Fe(III) and reduced Fe(II) form. At 3.85 mm such a pane of glass will have a light transmission of around 89% (measured with CIE Illuminant A) and a direct solar heat transmission of around 83% (measured according to ISO 9050; Air Mass 1.5).

Preferably the reflective layer is a layer of silver. However other similarly reflective substances (typically metals), such as aluminium, may also be used. Nonetheless, silver is the most preferred substance because of its reflectivity and pleasing aesthetic appearance. It is known to use silver as the reflective layer in prior art mirrors, but the thickness used is typically between 790 Å(coverage of approximately 750 mg/m²) and 1040 Å(coverage of approximately 985 mg/m²) because silver is a relatively expensive component of a mirror, and in the past the trend has been to try to minimise the amount required. However, despite the additional cost per mirror of increasing the thickness of the reflective layer, it is believed to be worthwhile for the reflectivity and durability benefits that are conferred. For the avoidance of doubt, throughout this specification the conversion between a silver thickness and its coverage in milligrams per square metre has been done using a measured density of silver of 9.5×10⁶ grams per cubic metre and the relationship:

$$Density = \frac{Mass}{Volume} = \frac{Mass}{( Area \times Thickness )}$$

Thus a silver thickness of 1600 Å equates to a coverage of approximately 1520 mg/m².

Advantageously, the thickness of the silver reflective layer is at least 1700 Å(coverage of approximately 1615 mg/m²), preferably up to around 2600 Å(coverage of approximately 2500 mg/m²) and further preferably in the range 1800 Å to 2300 Å(coverage in the range of approximately 1710 mg/m² to 2185 mg/m²).

An intermediate layer may be provided between the substrate and the reflective layer. The function of such a layer may be to sensitise the substrate in preparation for deposition of the reflective layer. Preferably the intermediate layer is a layer which contains tin, and which may be deposited as a solution of tin chloride (SnCl₂). Furthermore it may be provided in a mono layer thickness.

A second intermediate layer may moreover be provided between the first intermediate layer and the reflective layer. The function of this second layer may be to super-sensitise or activate the first intermediate layer in preparation for deposition of the reflective layer. The second intermediate layer may be deposited as an ionic solution comprising one or more of the following: chromium (II), nickel (II), palladium (II), platinum (II), zinc (II), bismuth (III), gold (III), indium (III), rhodium (III), ruthenium (III), titanium (III) and vanadium (III). Preferably the second intermediate layer is a layer of catalytic palladium, which may be deposited as a solution of palladium chloride (PdCl₂). It may also be provided in a mono layer thickness.

To afford additional protection to the reflective layer, a metal or metal-based layer is preferably provided between the reflective layer and the coating layer. The metal or metal-based layer may be deposited as a solution comprising one or more of the following: indium (I or II), chromium (II), iron (II), tin (II), copper (II or III), vanadium (II or III), titanium (II or III) and aluminium (III). Often it may be a layer of copper. However, in view of the environmental disadvantages of using copper, the metal or metal-based layer may include tin, and furthermore may include an adhesion promoter (to improve adhesion of the coating layer to the tin layer) such as organometallic silane, which may be in monolayer thickness.

Advantageously, the coverage of the metallic layer may be at least 200 mg/m² and up to around 400 mg/m², often 300 mg/m² to prevent tarnishing of the reflective layer, but if in combination with an adhesion promoter it may only be in monolayer thickness. As noted above with the mass-thickness relationship, the thickness of the metallic layer based on these values depends on the density of the metallic material used.

The coating layer may be a paint layer, provided as the outermost layer of the mirror. The coating layer may comprise a base coat and a top coat. A number of suitable paints are known in the art, e.g. a thermosetting polymer such as epoxy resin, polyester, polyurethane, acrylic and melamine, which may or may not include lead (lead-free being the better choice for environmental reasons), any one or more of which may be used in the present invention. Preferably the thickness of each of the base coat and the top coat is at least 20 μm (preferably up to around 30 μm, further preferably around 25 μm), to provide sufficient environmental protection for the reflective layer.

As mentioned above in describing the prior art solutions offered to maximise mirror reflection, the transparent substrate of the mirror of the present invention is further preferably a pane of low-iron glass. A low-iron glass (also known as “white” glass or “extra clear” glass) usually comprises less than 0.1% total iron (expressed as Fe₂O₃) and may exhibit a solar energy transmission of greater than 91% (measured according to ISO 9050:2003). The substrate may typically be provided in a thickness of between 1 mm and 2 mm, usually around 1.6 mm.

Preferably the solar mirror exhibits a reflectance which is at least 0.01 greater (a 1% difference) than a corresponding prior art mirror (being identical apart from the increased silver thickness) at least one wavelength in the range 300 nm to 2500 nm, and which is preferably at least 3% greater (i.e. a 3% difference) at least one wavelength in the range 300 nm to 1000 nm. Such an increase in the degree of reflectance may furthermore endure for the working lifetime of the mirror (at least 20 years).

A solar mirror according to the invention may possess a degree of curvature such that a number of these mirrors may be located together to form a trough array for concentrating solar energy onto a receiver tube positioned at the focal point, the receiver usually containing a heat transfer fluid such as oil. Alternatively a number of such solar mirrors may be located together to form a dish (resembling a satellite dish) for concentrating solar energy onto a receiver such as a Sterling engine at the focal point. Further alternatively a solar mirror may be in the form of a heliostat panel, which is able to track the position of the sun in the sky and reflect solar energy towards a tower-mounted receiver.

For a better understanding the present invention will now be more particularly described, by way of non-limiting example, with reference to and as shown in the accompanying schematic drawings (not to scale) in which:

FIG. 1 is an elevation showing a first use of a solar mirror according to the invention;

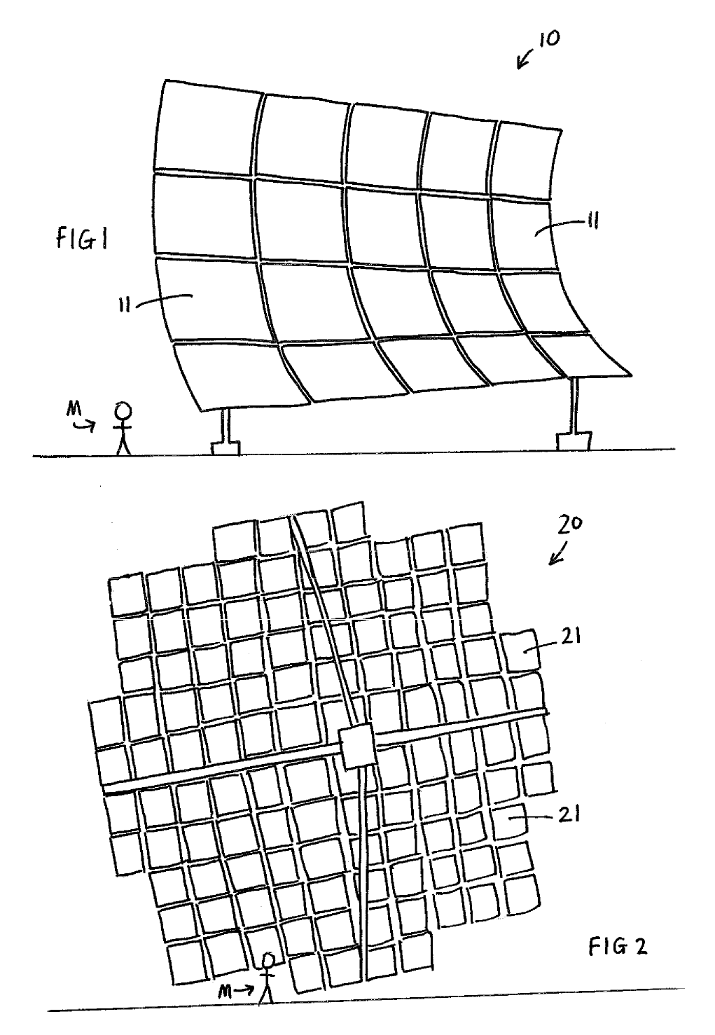

FIG. 2 is an elevation showing a second use of a solar mirror according to the invention;

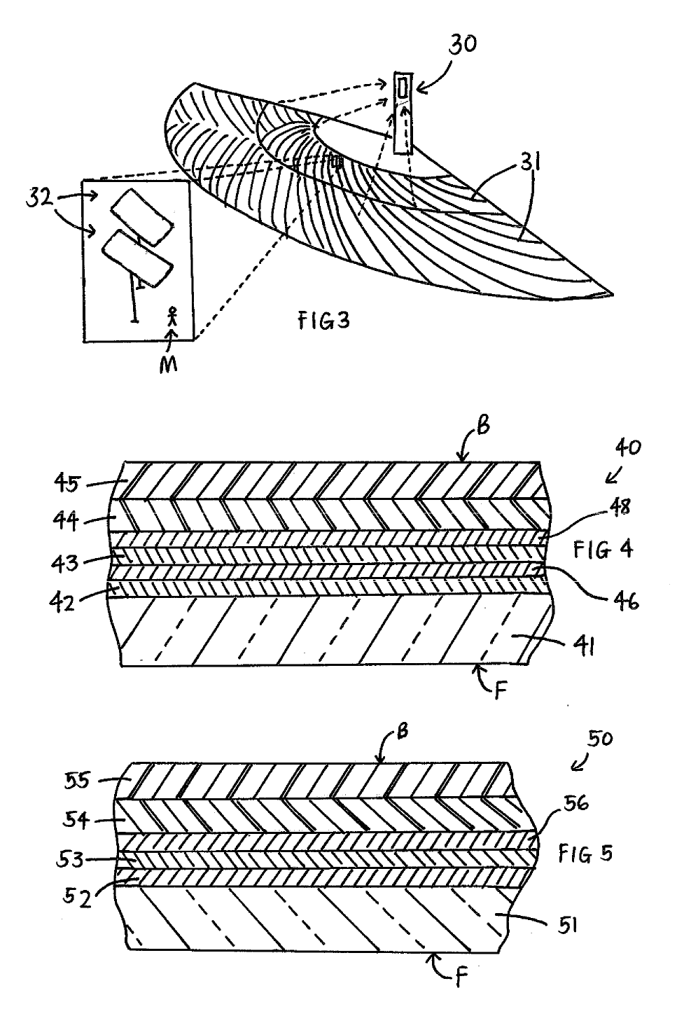

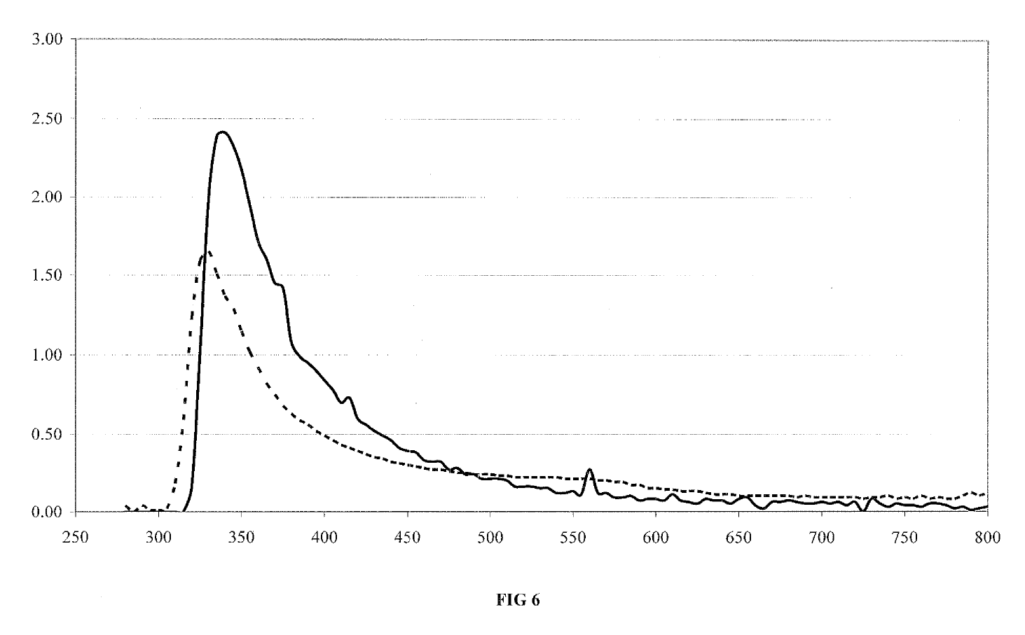

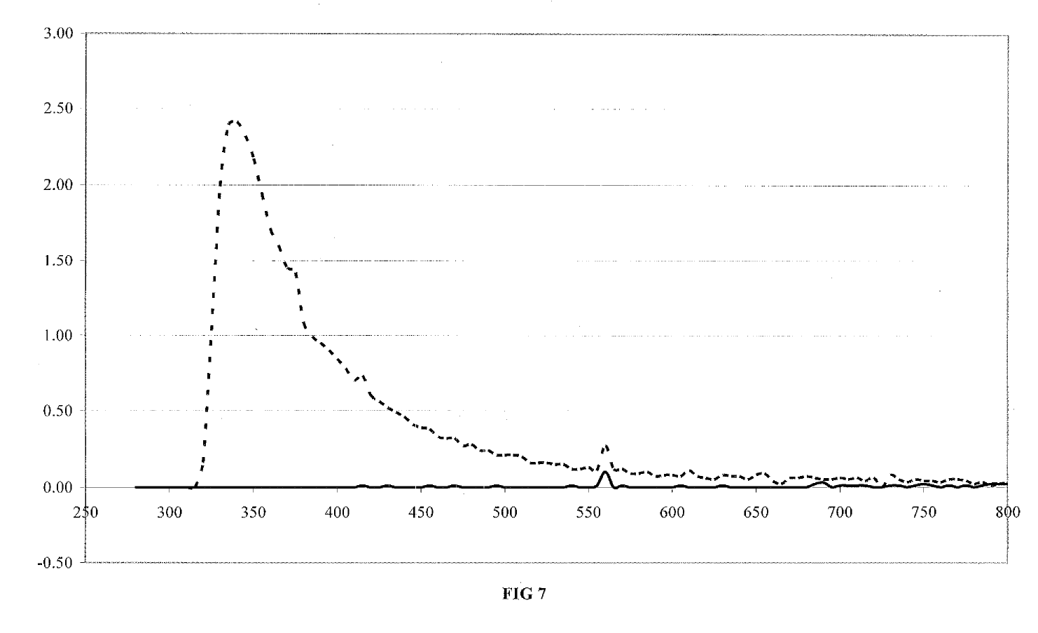

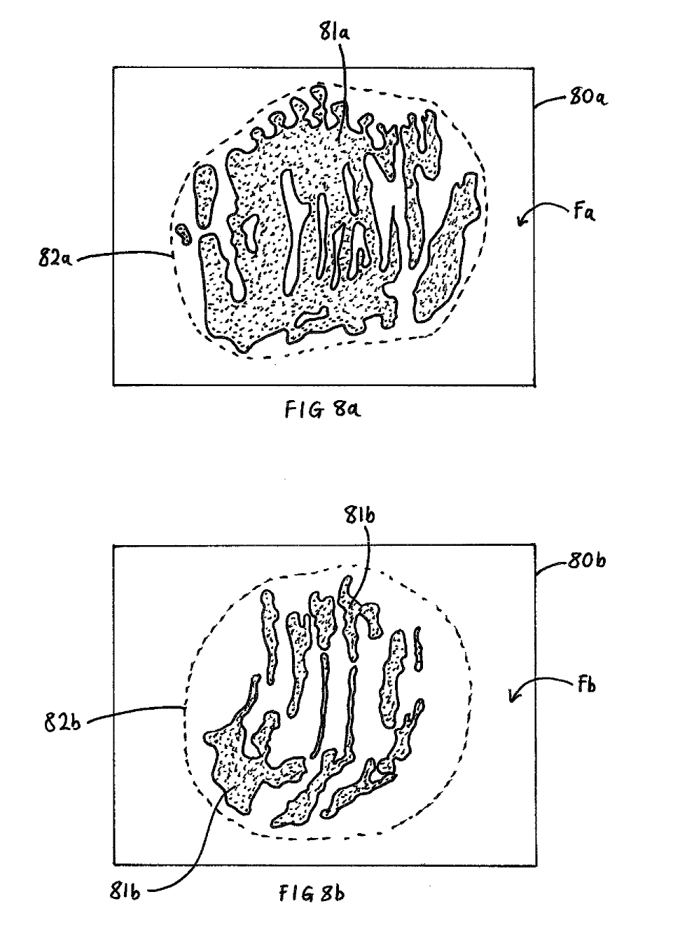

FIG. 3 is an elevation showing a third use of a solar mirror according to the invention;

FIG. 4 is a cross section through a solar mirror according to a first embodiment of the invention;

FIG. 5 is a cross section through a solar mirror according to a second embodiment of the invention;

FIG. 6 is a transmission curve showing percentage transmission on the y-axis and wavelength of light (measured in nanometres) on the x-axis for two prior art mirrors;

FIG. 7 is a transmission curve showing percentage transmission on the y-axis and wavelength of light (measured in nanometres) on the x-axis for comparison of a prior art mirror with a solar mirror according to the invention; and

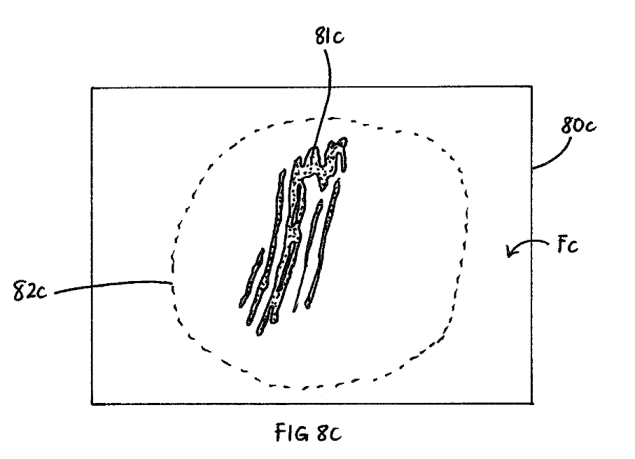

FIGS. 8a-8c are representations of mirrors showing the effect of adhesive “bleed-through”.

FIG. 1 shows a trough array 10, which is a 5×4 array of solar mirrors 11 used for concentrating solar energy onto a receiver tube (not shown) positioned at the focal point, the receiver usually containing a heat transfer fluid such as oil. To give an impression of the size of trough array 10, a stick man M, representative of a human being, is shown stood on the ground next to trough array 10.

FIG. 2 shows a dish 20, which is a collection of over one hundred solar mirrors 21, used for concentrating solar energy onto a receiver (not shown) such as a Sterling engine at the focal point. Again man M is shown stood on the ground next to dish 20 to give an impression of the size of it.

FIG. 3 shows a solar tower 30 and associated rows 31 of heliostats (sun-tracking solar mirrors) 32. A portion of one row 31 is magnified and to show the form and scale of each heliostat 32, which focus and reflect light (illustrated by dotted arrow lines) onto a receiver mounted on tower 30. Again man M is shown stood on the ground next to a pair of heliostats 32 to give an impression of their size.

In the arrangements shown in each of FIGS. 1 to 3, a solar mirror 11, 21, 32 illustrated may be of the type shown in either FIG. 4 or 5.

FIG. 4 shows a cross section through a mirror 40 which comprises a transparent substrate, in the form of a pane of low-iron glass 41 (although standard clear flat glass could also be used), having a stack of layers on one of its surfaces. The first layer provided directly on a surface of glass 41 is a first intermediate layer, in the form of a monolayer of tin 42, which sensitises said surface in readiness for deposition of the next layer. Deposited directly on the surface of tin monolayer 42 is a second intermediate layer, in the form of a monolayer of palladium 46, which is a catalytic layer, provided to promote deposition of the next layer. A reflective layer, in the form of a layer of silver 43, is deposited onto the monolayer of palladium 46. Silver layer 43 is provided in a thickness of around 1823 Å(coverage of approximately 1732 mg/m²). On top of silver layer 43, a metal-based layer, in the form of tin plus an adhesion promoter 48 is provided—this too is in monolayer thickness. Finally a coating layer, in the form of a base coat 44 of paint and a top coat 45 of paint is provided, the coverage of each being approximately 30 g/m². In use, mirror 40 is orientated such that IR, visible and UV radiation is incident on its front face (labelled F, the label B indicating the back face), is transmitted through glass 41 to silver layer 43, from where it is reflected.

FIG. 5 shows a cross section through a mirror 50 which is similar in construction to mirror 40, in that it comprises low-iron glass 51 (although again standard clear flat glass could also be used) having a tin monolayer 52 provided directly on one of its surfaces, silver layer 53 (of around 1474 Å thickness, equating to a coverage of approximately 1400 mg/m²) and coating layer in the form of base coat 54 and top coat 55. However in the embodiment shown in FIG. 5, silver layer 53 is provided directly on tin monolayer 52, and over silver layer 53 there is provided a metal layer, in the form of a layer of copper, having coverage of 300 mg/m² (equating to a thickness of approximately 336 Å, based on its density of 8.92×10⁶ g/m³). In use, mirror 50 is orientated such that IR, visible and UV radiation is incident on its front face (labelled F, the label B indicating the back face), is transmitted through glass 51 to silver layer 53, from where it is reflected.

Each of mirrors 40 and 50 may be manufactured in known fashion (with the exception that an increased amount of silver is used compared to prior art mirrors). Briefly the process includes:
cleaning, polishing and rinsing a pane of clear flat glass or low-iron glass 41, 51,
sensitising glass pane 41, 51 with an acidic solution of tin chloride to leave a monolayer of tin atoms 42, 52 on one surface,
(for mirror 40 only: spraying an acidic solution of palladium chloride onto the tin monolayer to leave a monolayer of catalytic palladium 46),
silvering glass 41, 51 by spraying a solution of a silver salt and reducing agent (e.g. silver nitrate, ammonia and sodium hydroxide) onto it, ensuring that a coverage of silver atoms of approximately 1400 mg/m² is achieved,
protecting silver layer 43, 53 by spraying either:
   a) a tin solution to form a monolayer of tin atoms, followed by an adhesion promoter such as an organometallic silane (for mirror 40 only), or
   b) a coppering solution to form a layer of copper, ensuring that a coverage of copper atoms of approximately 300 mg/m² is achieved (for mirror 50 only),
applying base coat 44, 54 and top coat 45, 55 paints, which adhere to the silane of mirror 40 and the copper layer of mirror 50,
baking mirrors 40 and 50 in an oven to thermoset the paints.

To illustrate the benefit in terms of IR, visible and UV transmission of a mirror according to the invention over and above prior art mirrors, two transmission curves were plotted as shown in FIGS. 6 and 7 with the wavelength of radiation in the range 250 nm to 800 nm on the x-axis and the percentage transmission on the y-axis.

In FIG. 6, the transmission curves for two prior art mirrors (without any paint layers to enable transmission to be measured) are shown: the solid line represents a copper-free mirror having a 975 Å thick silver layer (coverage of approximately 926 mg/m²) on a pane of 6 mm thick clear float glass, whilst the dotted line represents a mirror having a 947 Å thick silver layer (coverage of approximately 900 mg/m²) and a 336 Å thick copper layer (coverage of 300 mg/m²) on a pane of 3 mm thick clear float glass. FIG. 6 demonstrates that neither prior art mirror is able to entirely prevent transmission of electromagnetic radiation of a certain wavelength therethrough, especially in the wavelength range 300 nm to 450 nm. Such transmitted radiation would penetrate through to the paint (coating) layers, leading to the undesirable chemical changes and/or reactions affecting the silver layer discussed earlier.

FIG. 7 shows the transmission curves for a copper-free prior art mirror and a copper-free mirror according to the invention (both without any paint layers): the solid line represents mirror 40 described above (albeit without paint layers 44 and 45) having a 1823 Å thick silver layer (coverage of approximately 1732 mg/m²) on a pane of 6 mm thick clear float glass, whilst the dotted line represents a prior art mirror having a 975 Å thick silver layer (coverage of approximately 926 mg/m²) on a pane of 6 mm thick clear float glass. FIG. 7 demonstrates that in the provision of a thicker silver layer, it is possible to substantially reduce the amount of electromagnetic radiation transmitted through the glass 41, especially in the wavelength range 300 nm to 450 nm, resulting in both an increase in total reflection and reduction of the potential of long-term reduction in reflection due to UV degradation of mirror 40.

Samples of a mirror (labelled x, y and z) were produced for testing and cut into test piece sizes each of area 10 cm×10 cm. Sample x was made using 800 mg/m² of silver (and is thus an example of a prior art mirror of silver thickness 842 Å), sample y using 1000 mg/m² of silver (of thickness 1053 Å) and sample z using 1200 mg/m² of silver (of thickness 1263 Å). All three samples were made by silvering (as described above for mirror 40) panes of 3 mm thick clear soda-lime-silica float glass of approximate composition 72% SiO₂, 1% Al₂O₃, 0.1% Fe₂O₃, 13.5% Na₂O, 0.6% K₂O, 8.5% CaO, 4% MgO and 0.2% SO₃. Commercially available backing paints were used, these being nominally lead-free. The silvering operation was performed manually, rather than on a production line facility, to obtain an initial impression of the effect of increased silver thickness. As a result, the quality of the mirrors was much lower than would be obtained from an automated process, but were still able to yield meaningful results.

Each of samples x, y and z were exposed to accelerated weathering in terms of the following tests:

(1) 600 hours of copper-accelerated acetic acid salt spray (CASS) testing (according to standard ISO 9227:2006 “Corrosion Tests in Artificial Atmospheres—Salt Spray Tests”);
(2) 2400 hours of humidity testing, as described in Annex A of EN 1036:1999 “Glass in Building—Mirrors from Silver-Coated Float Glass for Internal Use”;
(3) at least 2000 hours of humidity testing under constant conditions of 85° C. and 85% relative humidity.

After the above accelerated weathering tests had each been completed the number of light-coloured flecks in the silver layer that could be seen with the naked eye were counted and recorded to be in the ratios as shown in Table I below (with prior art sample x being the benchmark against which improvements were recorded in each of the tests).

TABLE I

| | | Ratio of Number of |
|---|---|---|
| Test | Sample | Flecks per 100 cm² |
| (1) | x | 40 |
| | y | 12 |
| | z | 1 |
| (2) | x | 20 |
| | y | 5 |
| | z | 1 |
| (3) | x | 5 |
| | y | 2 |
| | z | 1 |

Each of samples x, y and z were also subjected to a separate visual inspection. Each sample had a patch of adhesive spread onto its back face B, as may be done to mount a mirror in preparation for its use. The samples were then placed into a controlled environment of 90° C. dry heat for 6 months. After this time had elapsed, the samples were inspected qualitatively to see what effect the adhesive had had on the mirror.

FIGS. 8a, 8b and 8c illustrate what was observed, and correspond to samples x, y and z respectively. In FIG. 8a, there was a large area of degradation 81a of mirror 80a observed via front face Fa, which manifested as foggy patches in the silver layer. The dotted line 82a represents the outline of the patch of adhesive applied to the back face Ba of mirror 80a. This is an unsurprising result for a prior art mirror.

FIG. 8b shows a lesser degree of degradation 81b of mirror 80b compared to mirror 80a, and FIG. 8c shows an almost negligible amount of degradation 81c of mirror 80c—it is surprising that relatively small increases in the thickness of the silver layer has such a marked effect of the amount of adhesive “bleed-through” observed. However it appears that such an increased thickness means that mirrors 80b and 80c are able to withstand (to a greater degree than a prior art mirror 80a) chemical attack by adhesive, which is thought to be activated at elevated temperatures, thereby reducing/preventing the degradation of the silver layer as a result of these chemical changes and/or reactions.

It has been shown above that there are benefits in terms of electromagnetic radiation transmission at certain wavelengths of a mirror according to the invention over and above prior art mirrors. Said benefits were demonstrated in FIG. 7 by comparing the transmission curves for a copper-free prior art mirror and a copper-free mirror according to the invention. These two samples only had the reflective metallic layers 43, 53 applied, and both were measured without paint layers 44, 54, or 45, 55 having been applied.

It is reasonable to assume that, when comparing complete mirrors (i.e. with paint layers 44, 54, or 45, 55 having been applied and thermoset) one would expect to see an increase in the amount of electromagnetic radiation being reflected by the metallic layer 43, 53 of the mirrors according to the invention, compared to a prior art mirror. It would also be reasonable to assume that this increase in the reflection of electromagnetic radiation would be proportionate to the difference in the amount of electromagnetic that is transmitted by a mirror according to the invention and a prior art mirror as shown in FIG. 7. Furthermore, it would be expected that the increase in the amount of electromagnetic radiation being reflected by the metallic layer 43, 53 of the mirrors according to the invention, would occur at or in the vicinity of the wavelength of highest transmission as shown in FIG. 7.

Reflectance measurements were made for mirror samples x and z, measured from the front face of each. Both samples were made by silvering panes of 3 mm thick clear soda-lime-silica float glass (as described above for mirror 40). The reflectance measurements are recorded below in Table II, and show that at specific wavelengths for mirror samples x and z, a mirror produced according to the present invention offers an increase in reflectance over a prior art mirror of at least 0.0099 at least one wavelength in the range 300 nm to 2500 nm, and preferably of at least 0.014 at least one wavelength in the range 300 nm to 1000 nm.

TABLE II

| | Silver Thickness | Wavelength | |
|---|---|---|---|
| Sample | (mg/m²) | (nm) | Reflectance |
| x | 800 | 335 | 0.2812 |
| | | 345 | 0.4016 |
| | | 355 | 0.5110 |
| z | 1200 | 335 | 0.2911 |
| | | 345 | 0.4143 |
| | | 355 | 0.5249 |

1-16. (canceled)

17. A solar mirror comprising:
a transparent glass substrate,
a reflective layer provided on a surface of the substrate, and
a coating layer provided over the reflective layer,
wherein the reflective layer is provided in a thickness of at least 1600 Å.

18. The solar mirror as claimed in claim 17, wherein the reflective layer is a layer of silver.

19. The solar mirror as claimed in claim 18, wherein the thickness of the reflective layer is at least 1700 Å.

20. The solar mirror as claimed in claim 17, wherein an intermediate layer is provided between the substrate and the reflective layer.

21. The solar mirror as claimed in claim 20, wherein the intermediate layer is a layer containing tin.

22. The solar mirror as claimed in claim 20, wherein a second intermediate layer is provided between the first intermediate layer and the reflective layer.

23. The solar mirror as claimed in claim 22, wherein the second intermediate layer is a layer containing palladium.

24. The solar mirror as claimed in claim 17, wherein a metal or metal-based layer is provided between the reflective layer and the coating layer.

25. The solar mirror as claimed in claim 24, wherein the metal or metal-based layer is a layer containing copper.

26. The solar mirror as claimed in claim 24, wherein the coverage of the metallic layer is at least 200 mg/m².

27. The solar mirror as claimed in claim 24, wherein the metal or metal-based layer includes tin and an adhesion promoter.

28. The solar mirror as claimed in claim 17, wherein the coating layer is a paint layer, which is provided as the outermost layer.

29. The solar mirror as claimed in claim 28, wherein the coating layer comprises a base coat and a top coat.

30. The solar mirror as claimed in claim 29, wherein the thickness of each of the base coat and the top coat is at least 20 μm.

31. The solar mirror as claimed in claim 17, wherein the transparent glass substrate is a pane of low-iron glass.

32. The solar mirror as claimed in claim 17, exhibiting reflectance which is at least 0.0099 greater than a corresponding mirror, being identical apart from the increased silver thickness, at least one wavelength in the range of 300 nm to 2500 nm.
